(19) United States
(12) Patent Application Publication
(10) Pub. No.: US 2017/0084233 A1
(43) Pub. Date: Mar. 23, 2017

(54) PIXEL CAPACITANCE MEASUREMENT

(71) Applicant: QUALCOMM MEMS Technologies, Inc., San Diego, CA (US)

(72) Inventors: Edward Keat Leem Chan, San Diego, CA (US); Bing Wen, Poway, CA (US); James Steven Edgar, San Diego, CA (US); Robert Steven Kawamoto, San Diego, CA (US); Robert Anderson Beckman, San Jose, CA (US)

(21) Appl. No.: 14/861,719

(22) Filed: Sep. 22, 2015

(51) Int. Cl. G09G 3/34; G09G 3/00

(52) U.S. Cl. CPC G09G 3/3466; G09G 3/006; G09G 2320/08; G09G 2330/12; G09G 2320/0242; G09G 2310/0248; G09G 2310/0291

(57) ABSTRACT

This disclosure provides systems, methods and apparatus for a capacitance measurement circuit. In one aspect, a circuit can inject charge onto an electrode of a display unit of a display. The circuit can also transfer charge from the electrode to a capacitor to generate a voltage corresponding to a capacitance between the electrode and another electrode of the display unit.

### TECHNICAL FIELD

This disclosure relates to electromechanical systems and devices. More specifically, the disclosure relates to measuring a capacitance of a pixel of a display.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In some implementations, each IMOD may include a movable element (that can include a mirror) that can be moved to positions to reflect light at particular wavelengths, and therefore, provide particular colors. In some implementations, the movable element of the IMOD may be moved to a new position from a starting point and under an application of voltages to electrodes of the IMOD. However, the movable element may move to a slightly different position than the expected position due to process variations, defects, noise, calibration issues, and other conditions. As a result, the IMOD may reflect light at a different wavelength than expected.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit capable of injecting charge onto a first electrode of a display unit, and the circuit further capable of transferring the charge on the first electrode to a capacitor to generate a voltage corresponding to a capacitance between the first electrode and a second electrode of the display unit.

In some implementations, the circuit comprises an operational amplifier (op-amp) having a first input, a second input, and an output; and a switch having a first terminal and a second terminal, the first terminal coupled with the first input of the op-amp, the second terminal coupled with the output of the op-amp, and wherein the capacitor has a first terminal and a second terminal, the first terminal coupled with the first terminal of the op-amp, the second terminal coupled with the output of the op-amp.

In some implementations, the switch is turned on to short the output of the op-amp with the first terminal of the op-amp to inject the charge onto the first electrode.

In some implementations, a test voltage at the second output of the op-amp is provided to the first electrode to inject the charge.

In some implementations, the test voltage corresponds to a voltage of a third electrode of the display unit, and the capacitance corresponds to a capacitance between the first electrode and the second electrode.

In some implementations, the first electrode is positioned between the second electrode and the third electrode.

In some implementations, the switch is turned off to no longer short the output of the op-amp with the first terminal of the op-amp to transfer the charge on the first electrode to the capacitor, wherein the first terminal of the op-amp is a negative input of the op-amp, and the first terminal of the op-amp is electrically coupled with the first electrode when the switch is turned off.

In some implementations, the capacitance indicates a position of the first electrode.

In some implementations, the circuit comprises a display including a plurality of the display units; a processor that is configured to communicate with the display, the processor being configured to process image data; and a memory device that is configured to communicate with the processor.

In some implementations, the circuit comprises a driver circuit including the circuit and configured to send at least one signal to the display; and a controller configured to send at least a portion of the image data to the driver circuit.

In some implementations, the circuit comprises an image source module configured to send the image data to the processor, wherein the image source module includes at least one component selected from the group consisting of a receiver, a transceiver, and a transmitter.

In some implementations, the middle electrode is associated with a movable element capable of being positioned between the second electrode and a third electrode of the display unit.

Another innovative aspect of the subject matter described in this disclosure can be implemented in a system comprising a pixel having a first electrode and a second electrode; a capacitor; a charging circuit capable of injecting charge onto the first electrode, and the circuit capable of transferring the charge on the first electrode to the capacitor to generate an output voltage corresponding to a capacitance between the first electrode and the second electrode of the pixel; and a controller capable of determining a state of the pixel based on the output voltage.

In some implementations, the state of the pixel is associated with a position of a movable element associated with the first electrode in relation to the second electrode and a third electrode of the pixel, and the controller is further capable of determining that the position of the movable element differs from an expected position of the movable element, and the controller is further capable of updating data indicating a voltage to be applied to the first electrode based on the determination that the position of the movable element differs from the expected position of the movable element.

In some implementations, the charging circuit comprises an operational amplifier (op-amp) having a first input, a second input, and an output; and a switch having a first terminal and a second terminal, the first terminal coupled with the first input of the op-amp, the second terminal coupled with the output of the op-amp, and wherein the capacitor has a first terminal and a second terminal, the first terminal coupled with the first terminal of the op-amp, the second terminal coupled with the output of the op-amp.

In some implementations, the switch is turned on to short the output of the op-amp with the first terminal of the op-amp to inject the charge onto the first electrode.

In some implementations, a test voltage at the second output of the op-amp is provided to the first electrode to inject the charge, the test voltage corresponding to a voltage of a third electrode of the pixel.

In some implementations, the switch is turned off to no longer short the output of the op-amp with the first terminal of the op-amp to transfer the charge on the first electrode to the capacitor.

Another innovative aspect of the subject matter described in this disclosure can be implemented in a method comprising changing a state of a display unit having a first electrode and a second electrode; applying a test voltage to an input of an operational amplifier (op-amp); providing the test voltage to the first electrode of the display unit; transferring charge from the electrode to a capacitor; and generating a voltage from the transferred charge on the capacitor, the voltage corresponding to a capacitance between the first electrode and the second electrode of the display unit.

In some implementations, the method comprises determining a position of the first electrode in relation to the second electrode based on the voltage.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is an example of a system block diagram illustrating an electronic device incorporating an IMOD-based display.

FIG. 8 is a circuit schematic of an example of a three-terminal IMOD.

FIG. 9 is an example of a timing diagram for the three-terminal IMOD of FIG. 8.

FIGS. 10A and 10B are an example of a movable element positioned at an unexpected position.

FIG. 11 is an example of capacitances of a three-terminal IMOD.

FIG. 12 is a circuit schematic of an example of a capacitance measurement circuit.

FIG. 13 is an example of a timing diagram for the capacitance measurement circuit of FIG. 12.

FIGS. 14A-H are examples of configurations of the capacitance measurement circuit of FIG. 12.

FIG. 15 is a flow diagram illustrating a method for measuring capacitance.

FIGS. 16A and 16B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some devices can have a capacitance that varies with voltage. For example, a pixel of a display, such as a liquid crystal of a liquid crystal display (LCD), can have its capacitance change as the voltages applied to its terminals also change. Interferometric modulators (IMODs) are EMS devices that can also be used as pixels in displays. IMODs can also have capacitances that vary with voltages applied to electrodes.

Each IMOD can include a movable element with a mirror (as a reflective plate) that can be positioned at various points in order to reflect light at specific wavelengths, and therefore, provide specific colors for the display. The movable element of one IMOD may be moved towards a particular position from a starting point and under an application of voltages to electrodes of the IMOD. However, the movable element of the IMOD may actually move to a slightly different position than expected from the application of the voltages, resulting in the IMOD reflecting light at a different wavelength than expected.

Some implementations of the subject matter described in this disclosure measure capacitances between electrodes of a device. For example, the capacitances between the electrodes of an IMOD can be used to determine the position of the movable element. A capacitance measurement circuit can be coupled with an electrode of the IMOD that is associated with the movable element. The capacitance measurement circuit can inject charge onto the electrode and then transfer the charge onto a capacitor that can be used to generate a voltage that can be correlated with capacitance. Capacitances between the three electrodes of the IMOD can be measured and used to determine the position of the movable element, which can then be used to adjust the voltages applied to the electrodes of the IMOD such that the movable element moves to the expected position.

Particular implementations of the subject matter described in this disclosure can be implemented to realize one or more of the following potential advantages. Determining capacitances between electrodes of an IMOD can be used to determine the position of the movable element, and therefore, provide an indication that the voltage applied to one or more of the electrodes of the IMOD should be adjusted to compensate for deviations from the expected position. As a result, the movable elements can be properly moved to the expected position and provide the proper color.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

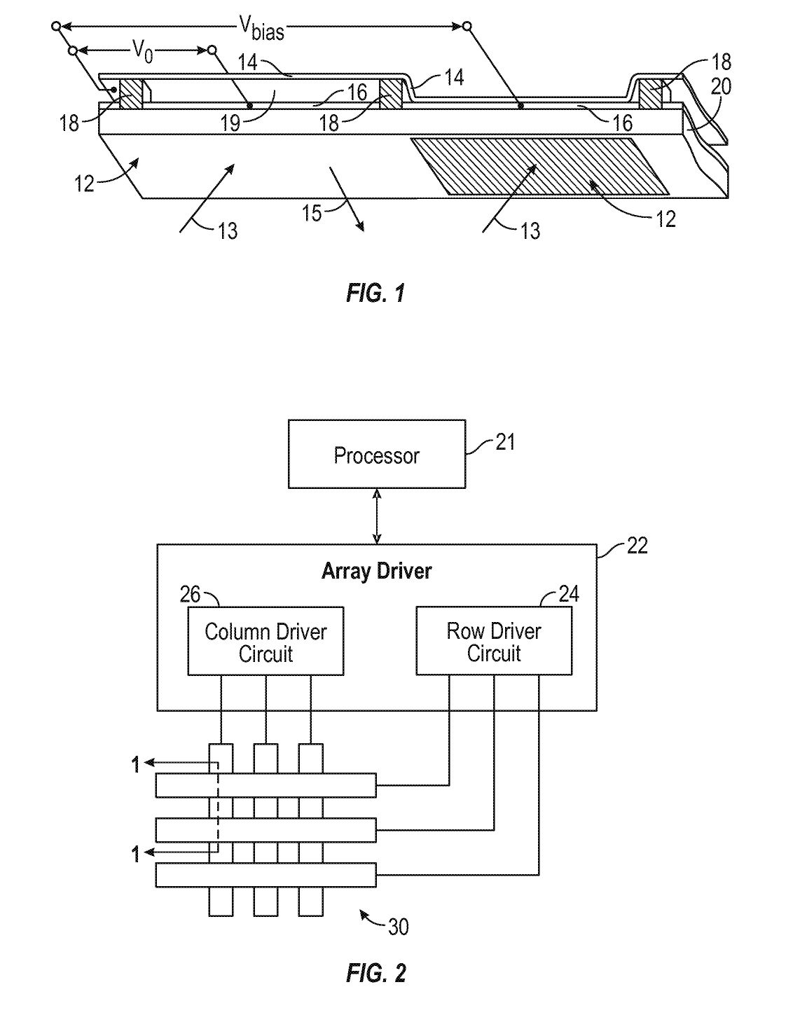

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

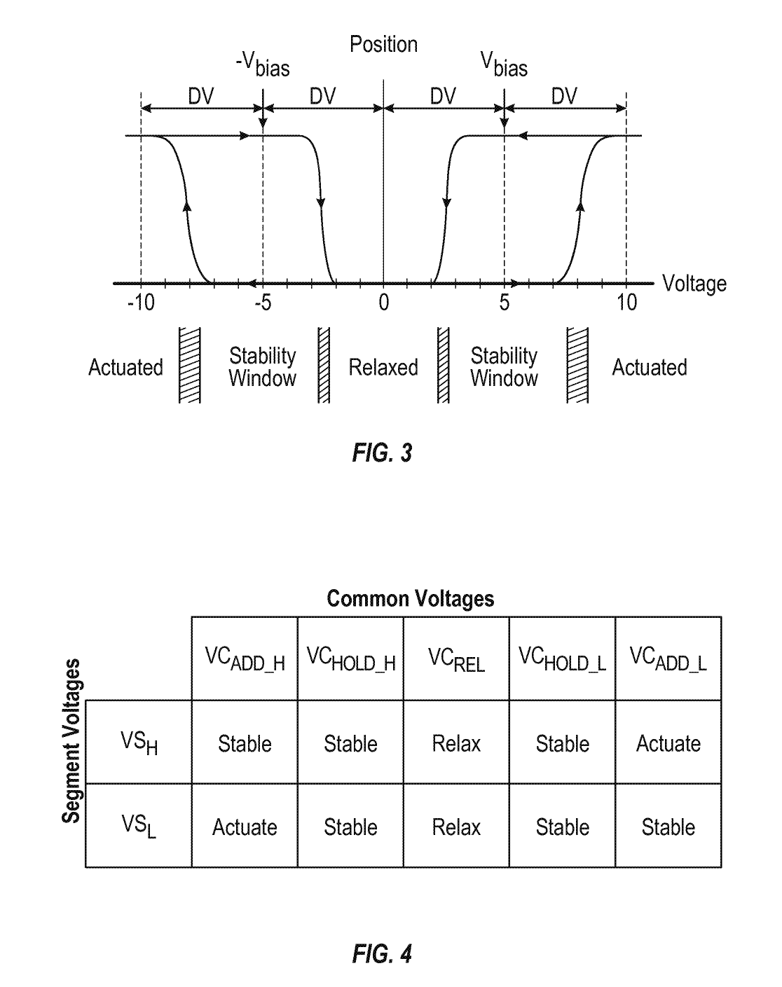

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_}_{H} or a low hold voltage VC_{HOLD}_{_}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_}_{H} or a low addressing voltage VC_{ADD}_{_}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

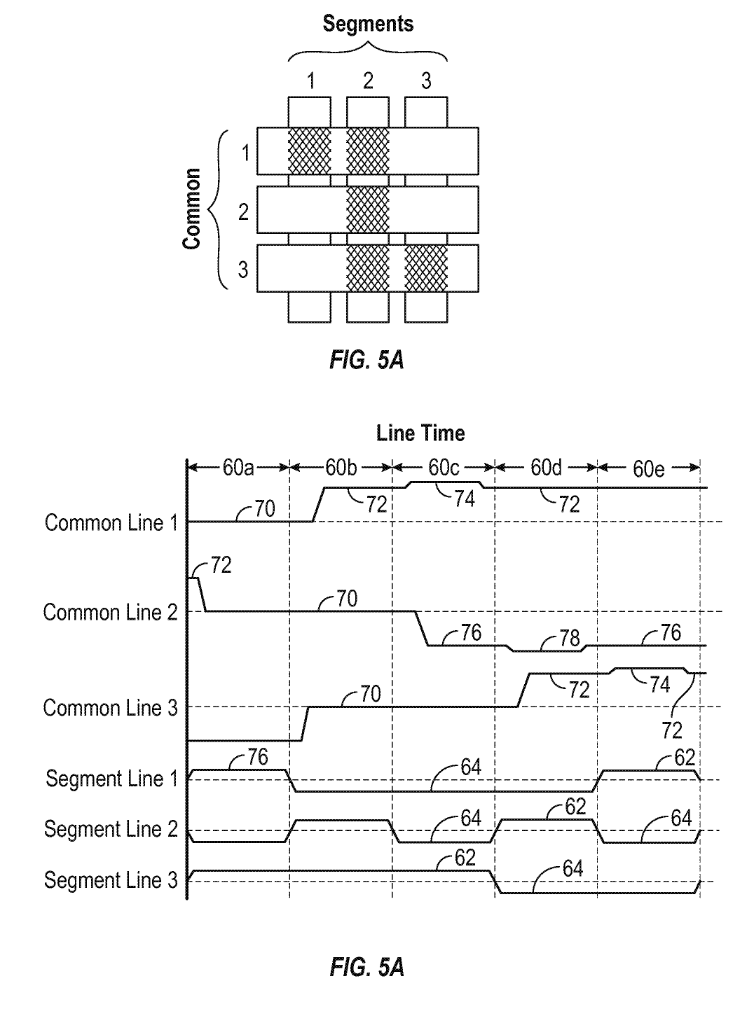

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD}_{_}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

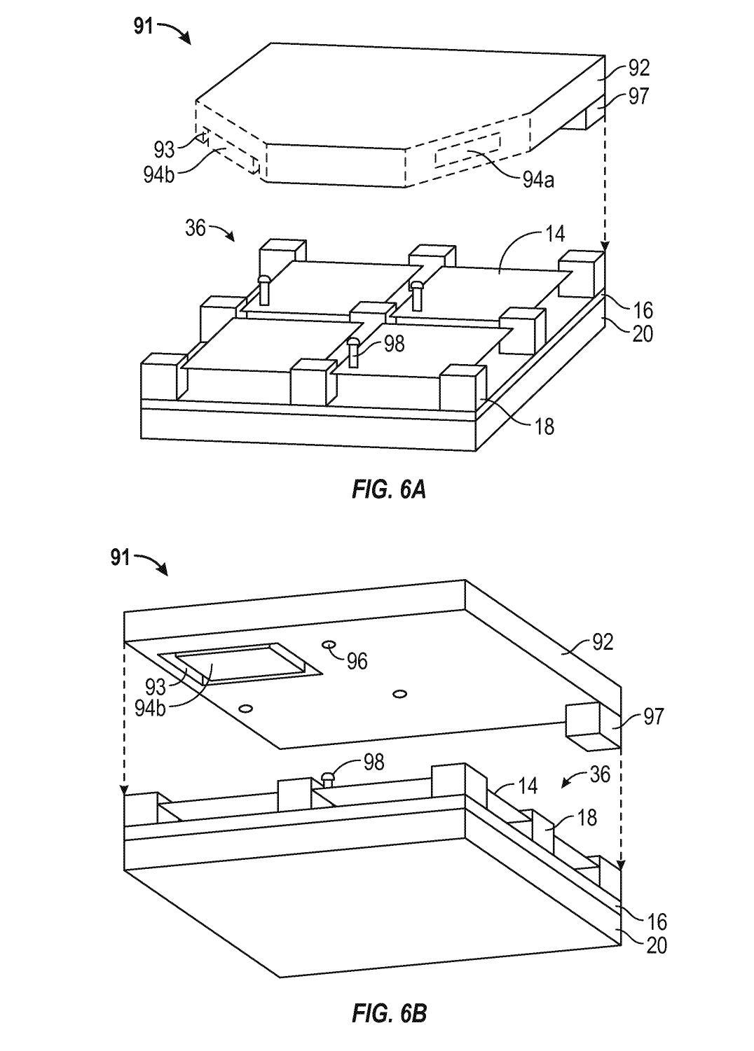

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

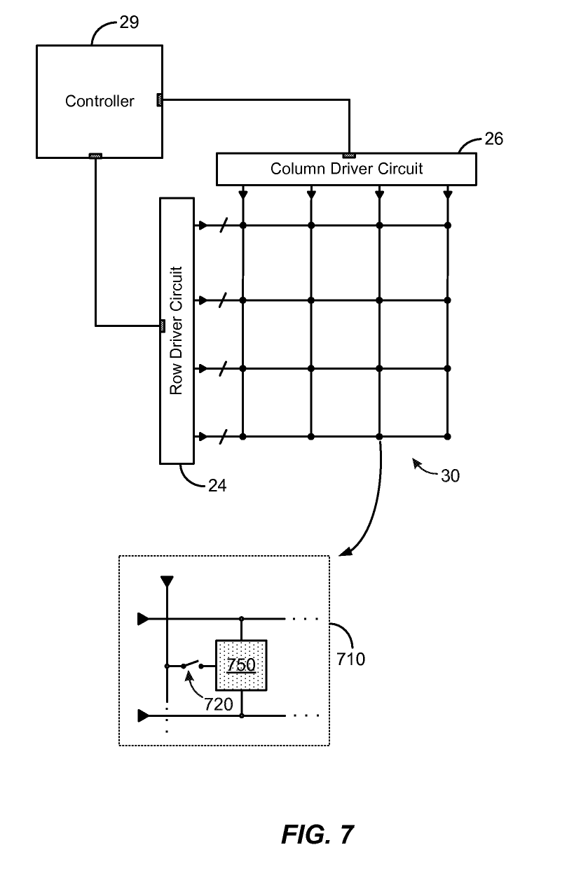

FIG. 7 is an example of a system block diagram illustrating an electronic device incorporating an IMOD-based display. FIG. 7 depicts an implementation of row driver circuit 24 and column driver circuit 26 of array driver 22 of FIG. 2 that provide signals to display array or panel 30, as previously discussed. Driver controller 29 receives data (e.g., from processor 21 or frame buffer 28) and provides signals to row driver circuit 24 and column driver circuit 26 based on the data to generate an image on display array 30, as discussed later.

The implementation of display module 710 in display array 30 may include a variety of different designs. As an example, display module 710 in the fourth row includes switch 720 and display unit 750. Display module 710 may be provided a row signal, reset signal, and a bias signal from row driver circuit 24. Display module 710 may also be provided a column (or data) signal and a common signal from column driver circuit 26. Display unit 750 may be coupled with switch 720, such as a transistor with its gate coupled to the row signal and its drain coupled with the column signal. Each display unit 750 may include an IMOD display element as a pixel.

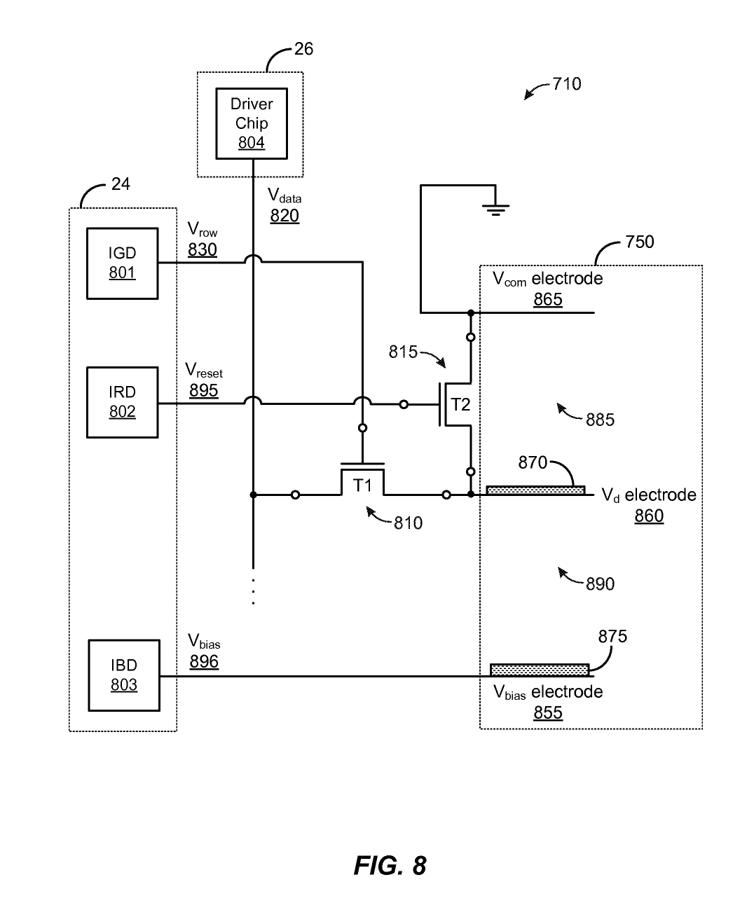

Some IMODs are three-terminal devices that use a variety of signals. FIG. 8 is a circuit schematic of an example of a three-terminal IMOD. In the example of FIG. 8, display module 710 includes display unit 750 (e.g., an IMOD). The circuit of FIG. 8 also includes switch 720 of FIG. 7 implemented as an n-type metal-oxide-semiconductor (NMOS) transistor T1 810. The gate of transistor T1 810 is coupled to receive voltage V_{row} 830 (i.e., a control terminal of transistor T1 810 is coupled to receive V_{row} 830 providing a row select signal) from row driver circuit 24 of FIG. 7 as a row signal. Transistor T1 810 is also coupled to receive V_{data} 820, which may be a voltage provided by column driver circuit 26 of FIG. 7 as a data signal. If V_{row} 830 is at a voltage to turn transistor T1 810 on, the voltage on V_{data} 820 may be applied to V_{d} electrode 860 of display unit 750. The circuit of FIG. 8 also includes another switch implemented as an NMOS transistor T2 815. The gate (or control) of transistor T2 815 is coupled with to receive Vᵣₑₛₑₜ 895 as a reset signal. The other two terminals of transistor T2 815 are coupled with V_{com} electrode 865 and V_{d} electrode 860. When transistor T2 815 is turned on (by a voltage of a reset signal on Vᵣₑₛₑₜ 895 applied to the gate of transistor T2 815), V_{com} electrode 865 and V_{d} electrode 860 of display unit 750 may be shorted together.

In FIG. 8, display unit 750 is a three-terminal IMOD including three terminals or electrodes: V_{bias} electrode 855, V_{d} electrode 860, and V_{com} electrode 865. Display unit 750 may also include movable element 870 and dielectric 875. Movable element 870 may include a mirror. Movable element 870 may be coupled with V_{d} electrode 860. Additionally, air gap 890 may be between V_{bias} electrode 855 and V_{d} electrode 860. Air gap 885 may be between V_{d} electrode 860 and V_{com} electrode 865. As movable element 870 is positioned, the sizes of air gaps 885 and 890 may change. In some implementations, display unit 750 may also include one or more capacitors. For example, one or more capacitors can be coupled between V_{d} electrode 860 and V_{com} electrode 865 and/or between V_{bias} electrode 855 and V_{d} electrode 860.

Movable element 870 includes or is coupled with V_{d} electrode 860 and can be positioned at points, or locations, between V_{bias} electrode 855 and V_{com} electrode 865 to provide light at a specific wavelength (and therefore color) at each specific point. Accordingly, display unit 750 can be in different states providing different colors based on the position of movable element 870. In particular, voltages applied to V_{bias} electrode 855, V_{d} electrode 860, and V_{com} electrode 865 may generate electric fields (e.g., between V_{bias} electrode 855 and V_{d} electrode 860, and between V_{com} electrode 865 and V_{d} electrode 860) that provide forces (of directions and magnitudes based on the electric fields) that act upon movable element 870, resulting in the positioning of movable element 870. Voltages for Vᵣₑₛₑₜ 895, V_{data} 820 (which is applied to V_{d} electrode 860 if transistor T1 810 is turned on), V_{row} 830, V_{com} electrode 865, and V_{bias} 896 (to be applied to V_{bias} electrode 855) may be provided by driver circuits such as row driver circuit 24 and column driver circuit 26. In some implementations, V_{com} electrode 865 may be coupled to ground rather than driven by row driver circuit 24 or column driver circuit 26, as depicted in FIG. 8.

In FIG. 8, row driver circuit 24 includes several circuits providing the voltages to display module 710 to position movable element 870: integrated gate driver (IGD) 801 providing V_{row} 830, integrated row driver (IRD) 802 providing Vᵣₑₛₑₜ 895, and integrated bias driver (IBD) 803 providing V_{bias} 896. Each of the circuits of row driver circuit 24 may provide the voltage at its output to one or more rows of display modules 710. Additionally, column driver circuit 26 includes driver chip 804 providing V_{data} 820 which can be provided to a column of display modules 710.

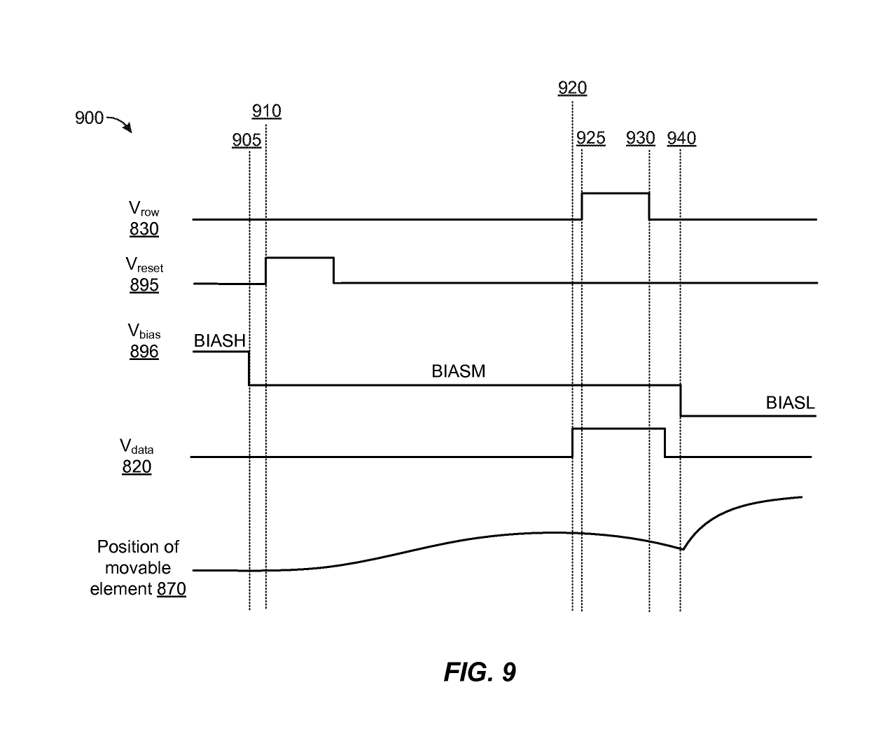

FIG. 9 is an example of a timing diagram for the three-terminal IMOD of FIG. 8. Timing diagram 900 in FIG. 9 shows signals as a sequence of applications of voltages to display module 710 by row driver circuit 24 and column driver circuit 26 to position movable element 870.

For example, in FIG. 9, at time 905, V_{bias} 896 can be changed from BIASH (e.g., 8 V) to BIASM (e.g., 0 V) by IBD 803, resulting in V_{bias} electrode 855 being at 0 V. Next, at time 910, Vᵣₑₛₑₜ 895 can be asserted by IRD 802 of row driver circuit 24 to turn on transistor T1 810 to short V_{com} electrode 865 and V_{d} electrode 870 together to position movable element 870 to a reset position. If V_{com} electrode 860 is grounded at 0 V as in FIG. 8, then at time 910 when Vᵣₑₛₑₜ 895 is asserted, V_{d} electrode 860 would also be at 0 V. As a result, each of the three electrodes of display unit 750 would be at 0 V, allowing the movable element 870 to begin to reposition to a reset position.

At time 920, V_{data} 820 can be provided by column driver circuit 26. For example, in FIG. 9, driver chip 804 drives V_{data} 820 to a voltage associated with the position that movable element 870 should be positioned to, for example, based on controller 29 using a lookup table (LUT) indicating relationships between voltages and the color to be provided by display unit 750. For example, the LUT may include data indicating the voltages that should be applied to V_{d} electrode 860 if movable element 870 to position it to different positions. Accordingly, driver chip 804 may provide V_{data} 820 at this voltage.

Next, at time 925, V_{row} 830 is turned on by IGD 801 to apply V_{data} 820 to V_{d} electrode 860. At time 930, V_{row} 830 can be de-asserted such that movable element 870 is now floating after being charged to V_{data} 820. At time 940, V_{bias} 896 can transition to BIASL or BIASH (BIASL, for example, at −8 V in FIG. 9) based on having display unit 750 being at a particular polarity (based on the direction of the electric fields generated by the voltages of the electrodes) to reduce charge accumulation affects, and movable element 870 can begin to position toward its intended position to reflect light at a wavelength corresponding to the intended position. Accordingly, a sequence of voltages V_{row} 830, Vᵣₑₛₑₜ 895, V_{bias} 896, and V_{data} 820 can be applied to set voltages of the electrodes of display unit 750 to position movable element 870.

However, positioning movable element 870 can be imprecise due to process variations, defects, noise, calibration issues, and/or other conditions affecting the voltages received by the terminals of the IMOD. For example, if movable element 870 should move from a position corresponding to red to a position corresponding to blue, then 5 V may need to be applied to an electrode, such as V_{d} electrode 860. However, the electrode may receive 4.98 V instead (due to the aforementioned conditions), and therefore, movable element 870 may be positioned at a slightly incorrect position rather than the expected position. Accordingly, display unit 750 would not reflect light at the intended wavelength.

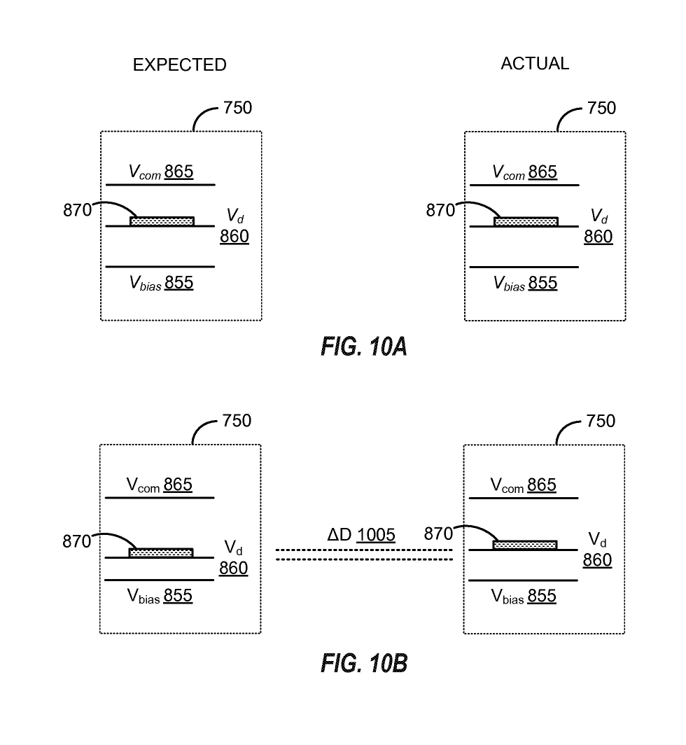

FIGS. 10A and 10B are an example of a movable element positioned at an unexpected position. In FIG. 10A, movable element 870 may be at a reset position, for example, following time 905 and before time 925 in FIG. 9. In FIG. 10B, the signals as indicated by timing diagram 900 in FIG. 9 can be applied and movable element 870 moves from the reset position. However, ΔD 1005 indicates that the expected position of movable element 870 differs from the actual position of movable element 870, resulting in movable element 870 reflecting light at a different wavelength than expected.

In some implementations, display array 30 can be calibrated by applying a voltage that is expected to position movable element 870 of display unit 750 to a position associated with the voltage to reflect light at a particular wavelength. For example, controller 29 in FIG. 7 can use a LUT as a data storage mechanism associating voltages to be applied to the electrodes of display unit 750 with the color or position that the movable element 870 should be at if the voltages are applied, as previously discussed. After the voltages are applied, the position of movable element 870 can be determined. If the actual position of movable element 870 is different than the expected position of movable element 870, then controller 29 can update data in the LUT by adjusting the voltages associated with the positions. For example, controller 29 can update the LUT so that a higher voltage is applied to an electrode such as V_{d} electrode 860 the next time movable element 870 of display unit 750 should be positioned to the same position from the same starting position so that movable element 870 can be positioned to the expected position.

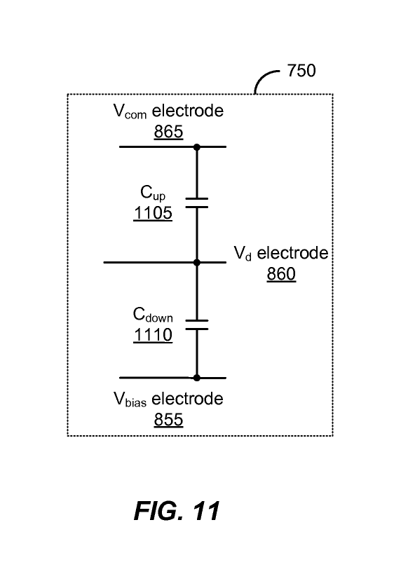

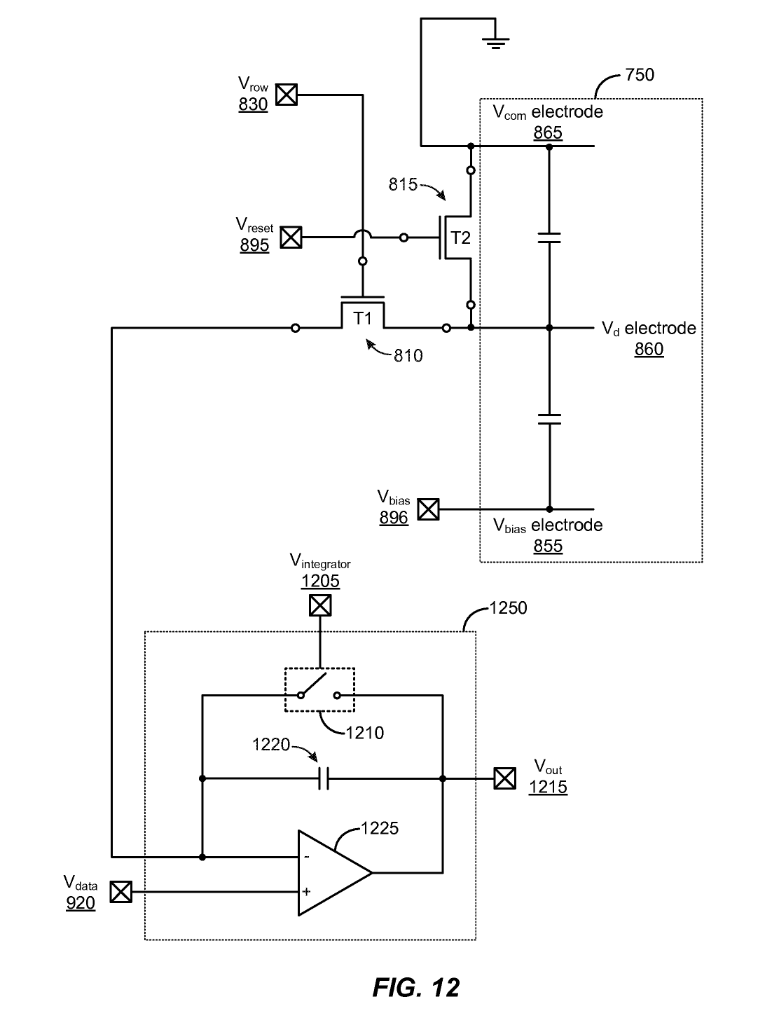

The position of movable element 870 can be determined by measuring (or determining) capacitances between electrodes of display unit 750 of display module 710. FIG. 11 is an example of capacitances of a three-terminal IMOD. In FIG. 11, Cᵤₚ 1105 is the capacitance between V_{d} electrode 860 and V_{com} electrode 865 of display unit 750. C_{down} 1110 is the capacitance between V_{d} electrode 860 and V_{bias} electrode 855. Cᵤₚ 1105 includes the capacitance of air gap 885 and C_{down} 1110 includes the capacitance of air gap 890. As movable element 870 is positioned between V_{com} electrode 865 and V_{bias} electrode 855, the sizes of air gaps 885 and 890 change, resulting in changes in the capacitances Cᵤₚ 1105 and C_{down} 1110. That is, display unit 750 can have capacitances Cᵤₚ 1105 and C_{down} 1110 vary as the voltages applied to V_{com} electrode 865, V_{d} electrode 860, and V_{bias} electrode 855 change. For example, as movable element 870 is positioned farther away from V_{bias} electrode 855 due to the application of voltages on the electrodes, the distance between V_{bias} electrode 855 V_{d} electrode 860 increases since V_{d} electrode 860 is part of and coupled with movable element 870, resulting in C_{down} 1110 decreasing since distance is inversely proportional to capacitance in a parallel plate capacitor model. By contrast, Cᵤₚ 1105 would increase. Accordingly, the capacitances Cᵤₚ 1105 and C_{down} 1110 can be correlated with and used to determine the position of movable element 870.

FIG. 12 is a circuit schematic of an example of a capacitance measurement circuit. The capacitance measurement circuit in FIG. 12 can be used to determine Cᵤₚ 1105 and C_{down} 1110 in FIG. 11. In other implementations, a similar circuit can be used for other types of devices. For example, two-terminal devices such as those used in liquid crystal displays can also be coupled with capacitance measurement circuit 1250 to determine their capacitances (e.g., a single capacitance measurement corresponding to the capacitance between their two electrodes or terminals).

In FIG. 12, capacitance measurement circuit 1250 includes operational amplifier (op-amp) 1225 implementing a charge integrator with integration capacitor 1220 and integrator reset switch 1210. Op-amp 1225 is coupled to receive a voltage V_{data} 920 at its positive input. The output of op-amp 1225 is coupled with integration capacitor 1220 and integrator reset switch 1210 to provide a voltage Vₒᵤₜ 1215 at an output. Integration capacitor 1220 and integrator reset switch 1210 are also coupled with the negative input of op-amp 1225. Integrator reset switch 1210 can be implemented with a transistor. The negative input of op-amp 1225 is also coupled with transistor T1 810 of display module 710. Capacitance measurement circuit 1250 can be used to determine the position of movable element 870 by injecting charge onto V_{d} electrode 860 and then collecting the charge from V_{d} electrode 860 onto integration capacitor 1220, which can result in a voltage Vₒᵤₜ 1215 that can be correlated with Cᵤₚ 1105 or C_{down} 1110 and used to determine the position of movable element 870.

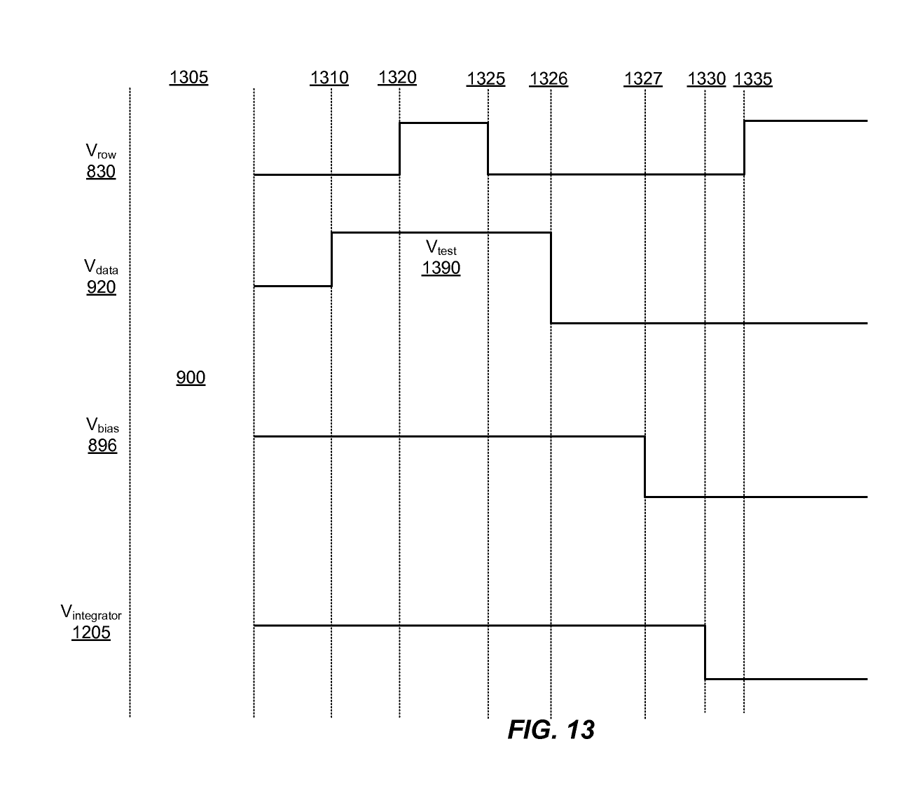

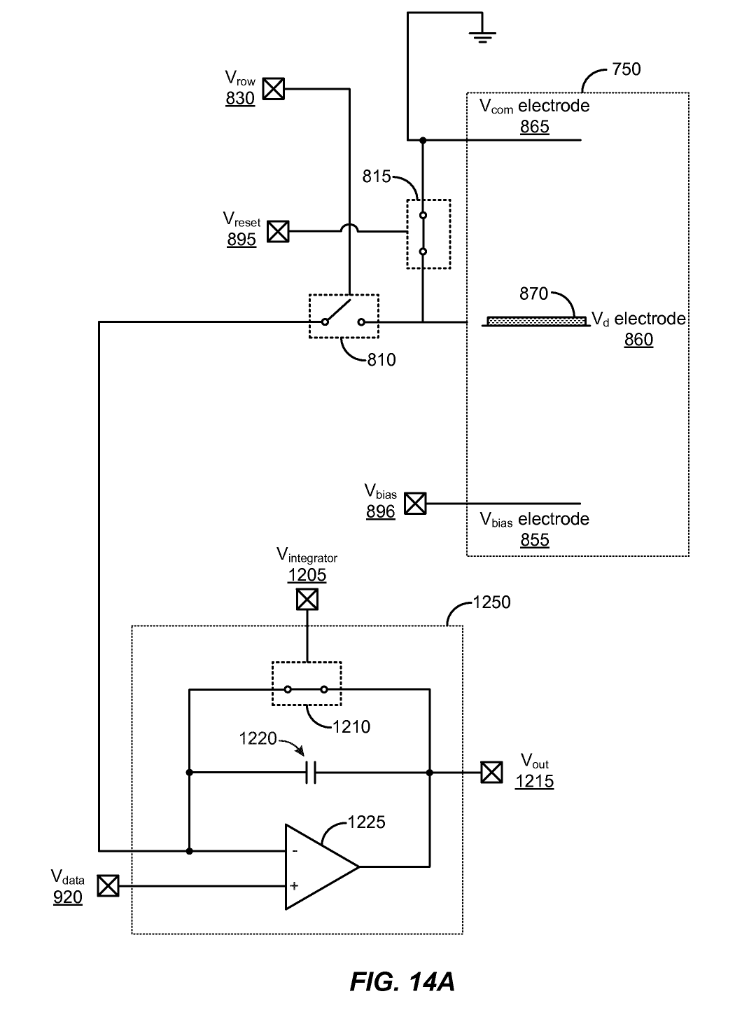

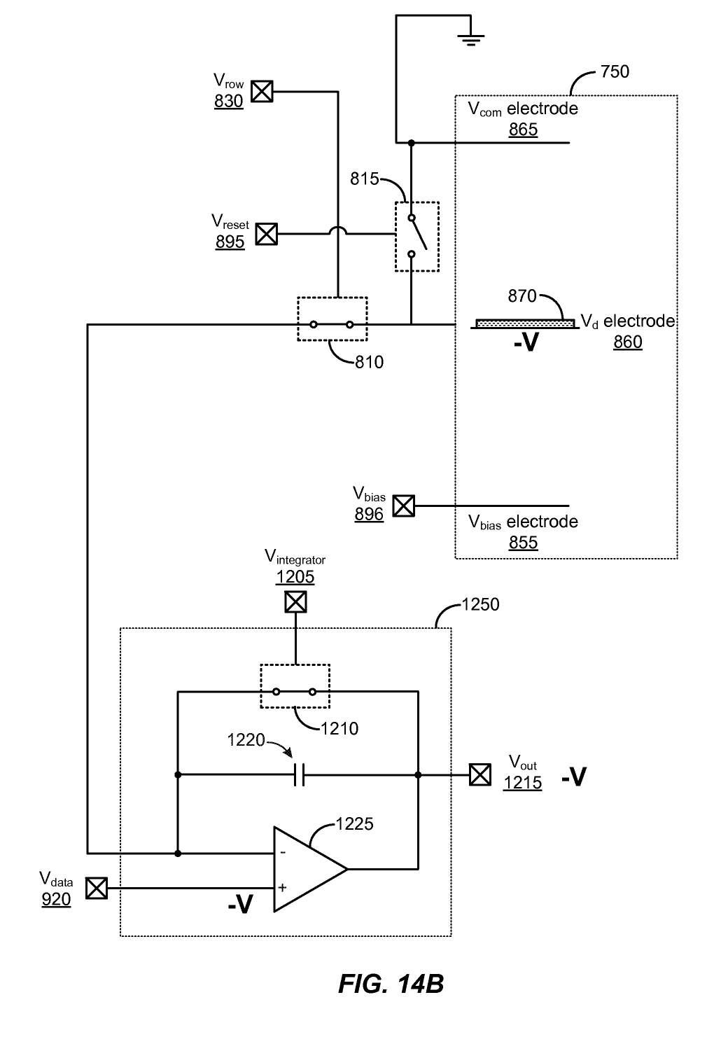

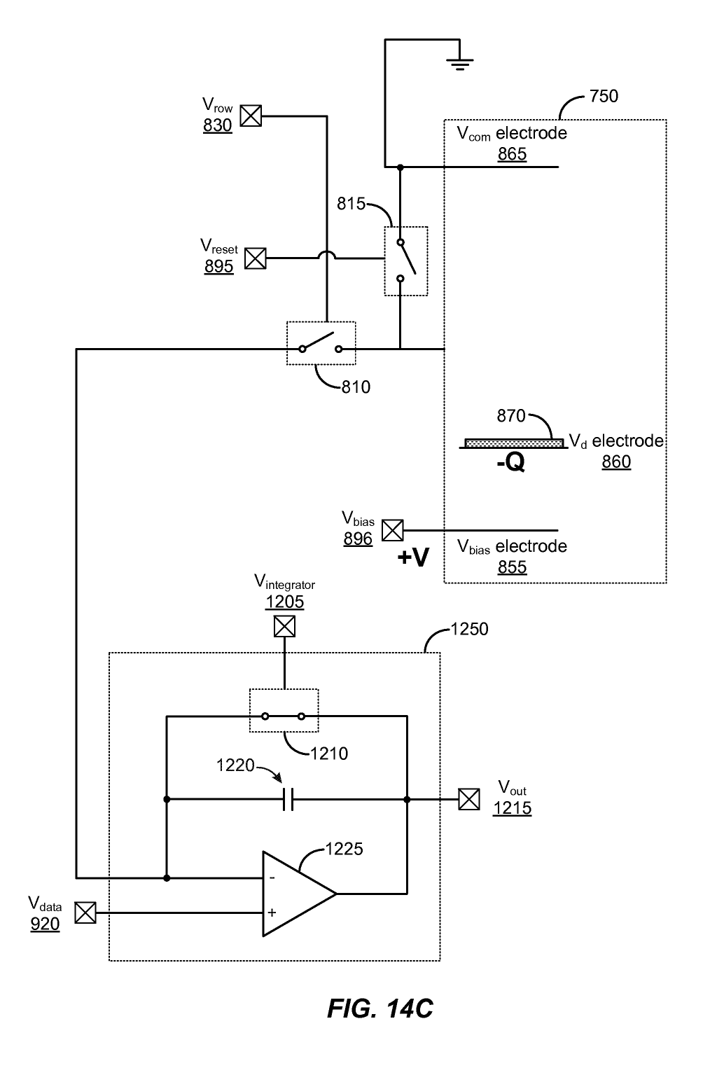

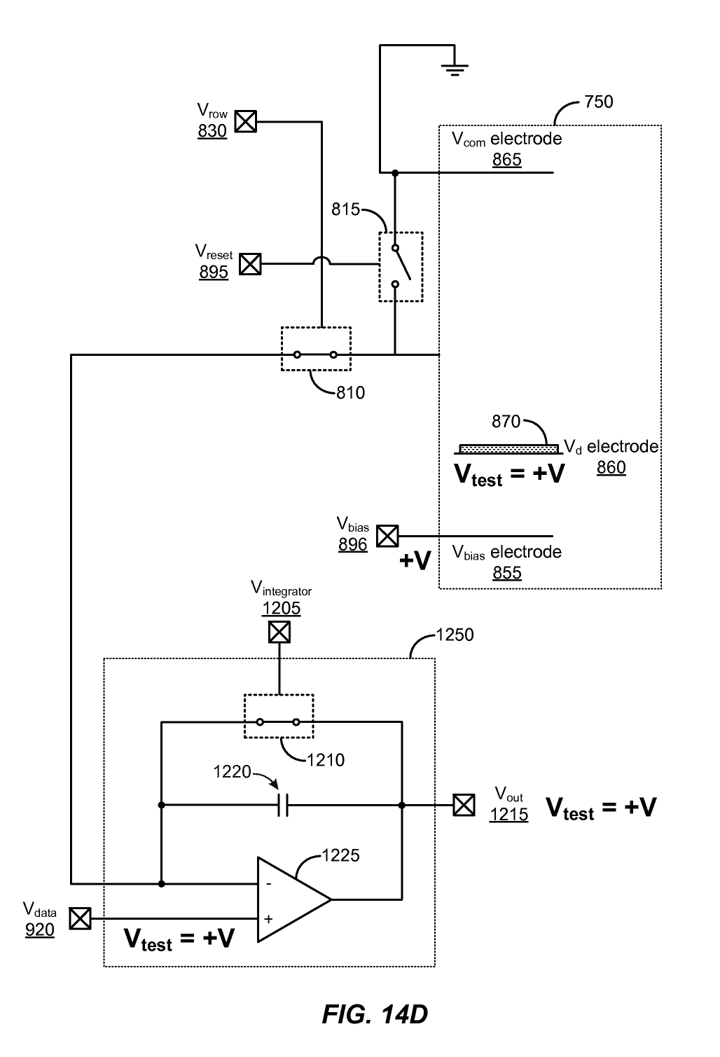

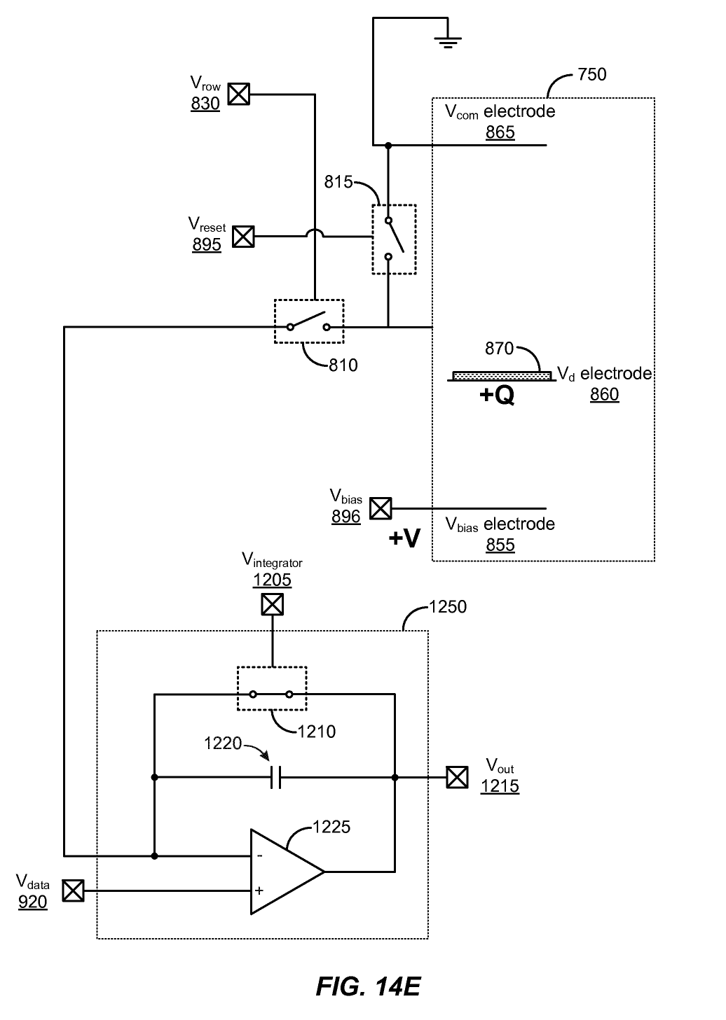

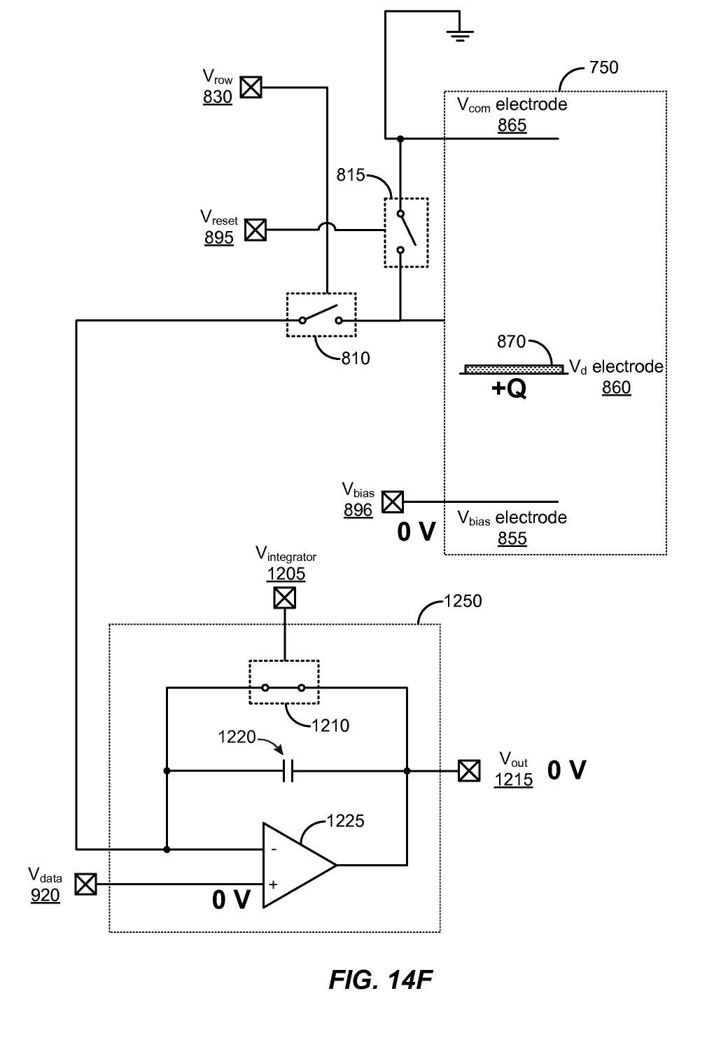

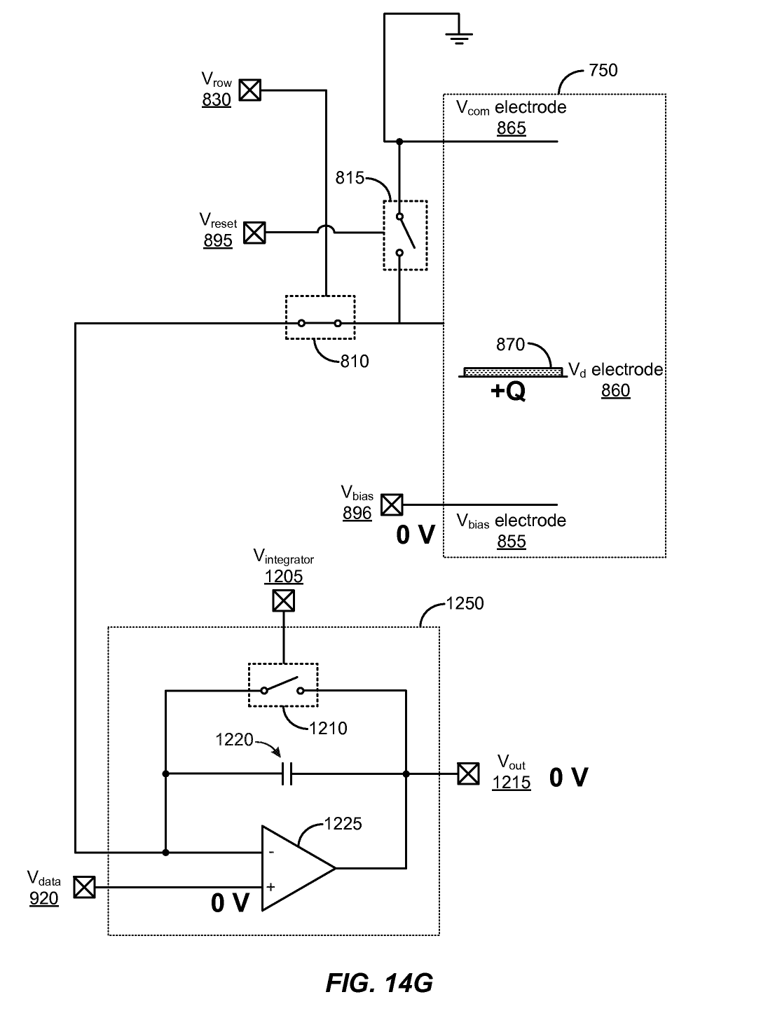

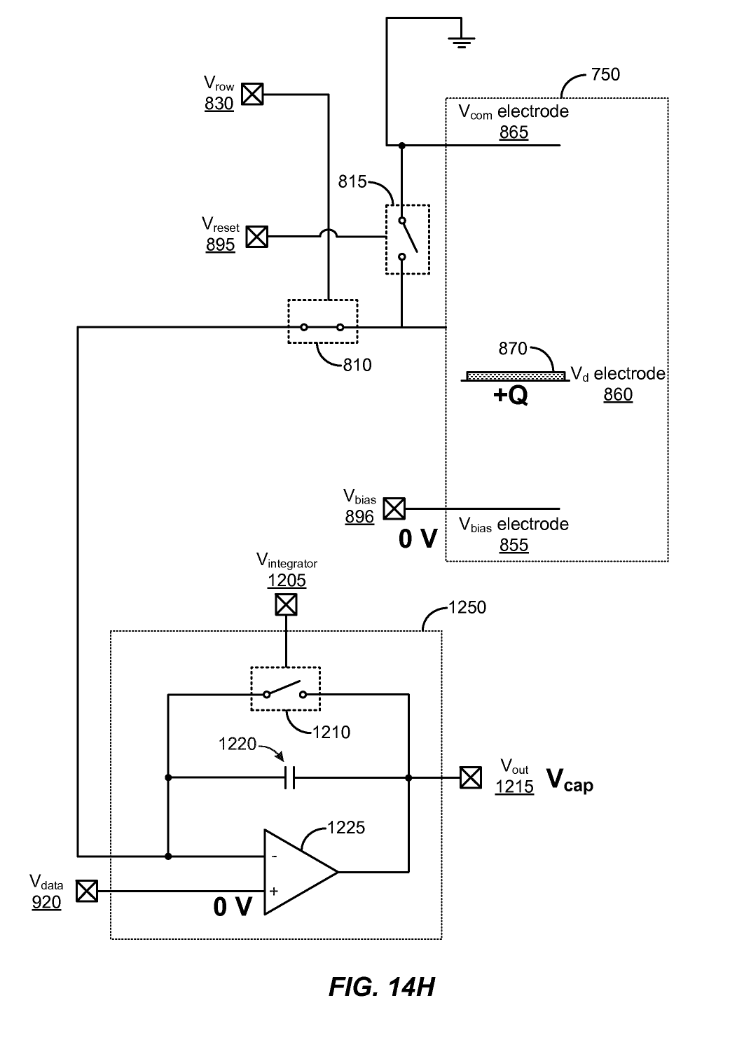

In more detail, FIG. 13 is an example of a timing diagram for the capacitance measurement circuit of FIG. 12. FIGS. 14A-H are examples of configurations of the capacitance measurement circuit of FIG. 12. In FIGS. 14A-H, transistors T1 810 and T2 815 are conceptualized as switches 810 and 820, respectively.

In FIG. 13, during time 1305, display module 750 can be provided a sequence of voltages, such as in timing diagram 900 of FIG. 9, to position movable element 870 to an intended position. For example, in FIG. 14A, movable element 870 can be positioned to a reset position by closing (i.e., turning on or making electrically conductive) switch 815 to short V_{d} electrode 860 with V_{com} electrode 865 so that both are 0 V, similar to time 910 in FIG. 9. Switch 810 is opened (i.e., turned off or electrically non-conductive) and integrator reset switch 1210 is closed so that V_{data} 920 at the positive input of op-amp 1225 is provided to the output of op-amp 1225 due to integrator reset switch 1210 shorting the output of op-amp 1225 with its negative input.

Next, in FIG. 14B, switch 810 can be closed and switch 815 can be opened. Additionally, a voltage corresponding to the intended position of movable element 870 can be provided on V_{data} 920 (indicated as −V) and provided at the output of op-amp 1225 at Vₒᵤₜ 1215. Since integrator reset switch 1210 is closed, shorting the output of op-amp 1225 with its negative input, the voltage on V_{data} 920 can be provided to V_{d} electrode 860 since switch 810 is also closed, as indicated in FIG. 14B, and similar to time 925 in FIG. 9. Next, in FIG. 14C, switch 810 can be opened and V_{bias} 896 is applied to provide a voltage for V_{bias} electrode 855 (indicated as +V), resulting in charge (indicated as −Q) building or accumulating upon V_{d} electrode 860 of movable element 870 due to the voltage difference between V_{d} electrode 860 and V_{bias} electrode 855, and therefore, movable element 870 moves towards an intended position, similar to time 940 in FIG. 9.

However, as previously discussed, the actual position that movable element 870 is positioned to may differ than the intended or expected position. Accordingly, capacitance measurement circuit 1250 can be used to determine whether the actual position of movable element 870 is the intended, or expected, position.

For example, at time 1310 in FIG. 13, V_{data} 920 can be set to a test voltage Vₜₑₛₜ 1390 to determine Cᵤₚ 1105 or C_{down} 1110. In particular, if the voltage of V_{com} electrode 865 is 0 V (as in FIG. 12), then the charge that is injected onto V_{d} electrode 860 of movable element 870 can be expressed as Q(Vₜₑₛₜ)=(Vₜₑₛₜ*Cᵤₚ)+(Vₜₑₛₜ−V_{bias})C_{down}, where Q is the charge on movable element 870 when Vₜₑₛₜ 1390 is applied.

Accordingly, if Vₜₑₛₜ 1390 is 0 V, then C_{down} 1110 can be expressed as C_{down}=−Q/V_{bias}. That is, if Vₜₑₛₜ 1390 is the same voltage as V_{com} electrode 865 (0 V) and applied to V_{d} electrode 870, then the charge is based on C_{down} 1110 due to the Cᵤₚ 1105 portion of the above equation equaling zero. By contrast, if Vₜₑₛₜ 1390 is the same voltage as V_{bias} electrode 855 as provided by V_{bias} 896, then Cᵤₚ 1105 can be expressed as Cᵤₚ=Q/Vₜₑₛₜ. That is, if Vₜₑₛₜ 1390 is the same voltage as V_{bias} electrode 855, then the charge on V_{d} electrode 860 of movable element 870 is based on Cᵤₚ 1105 due to the C_{down} 1110 portion of the above equation equaling zero.

In FIG. 13, V_{data} 920 is set to the same voltage as V_{bias} 896 provided to V_{bias} electrode 855 (i.e., Vₜₑₛₜ 1390 is set to V_{bias} 896) at time 1310 to measure Cᵤₚ 1105. Additionally, at time 1320, V_{row} 830 can be asserted such that V_{data} 920 providing Vₜₑₛₜ 1390 as in FIG. 13, is applied to V_{d} electrode 860. Accordingly, as depicted in FIG. 14D, switch 810 is closed and V_{data} 920 (set to Vₜₑₛₜ 1390) is provided to V_{d} electrode 860 so that it is at Vₜₑₛₜ 1390.

At time 1325, V_{row} 830 can be de-asserted such that switch 810 is opened, as depicted in FIG. 14E. Accordingly, the charge (indicated as +Q) on V_{d} electrode 860 of movable element 870 is based on Cᵤₚ 1105. As previously discussed, Cᵤ=Q/Vₜₑₛₜ when V_{data} 920 is set to a Vₜₑₛₜ 1390 matching V_{bias} 896. Accordingly, all of the accumulated charge is due to Cᵤₚ 1105, with C_{down} 1110 not affecting the amount of charge on movable element 870.

Next, capacitance measurement circuit 1250 can begin a charge integration process to collect the charge onto integration capacitor 1220 to generate a voltage Vₒᵤₜ 1215 that can be correlated with Cᵤₚ 1105. For example, at time 1326, V_{data} 920 is set to 0 V. This results in the 0 V V_{data} 920 also being provided by op-amp 1225 at its output for Vₒᵤₜ1215. At time 1327, V_{bias} 896 can be ramped to 0 V (or BIASM) to apply 0 V to V_{bias} electrode 855, as depicted in FIG. 14F.

At time 1330, V_{integrator} 1205 can be asserted (e.g., by controller 29) to open integrator reset switch 1210. This would result in the output of op-amp 1225 no longer being shorted by integrator reset switch 1210 to the negative input of op-amp 1225. Additionally, V_{row} 830 can be asserted at time 1335 to close switch 810, as depicted in FIG. 14G. As a result of closing switch 810, all of the charge on V_{d} electrode 860 of movable element 870 is transferred onto integration capacitor 1220, and the newly-developed charge across capacitor 1220 generates a voltage V_{cap} for Vₒᵤₜ 1215, as depicted in FIG. 14H. The voltage at Vₒᵤₜ 1215 (V_{cap} in FIG. 14H) is based on Cᵤₚ 1105, and therefore, can be used to determine Cᵤₚ 1105.

The technique can be repeated with V_{data} 920 being set to a voltage Vₜₑₛₜ 1390 that is the same voltage as V_{com} electrode 865 (0 V) to determine C_{down} 1110. For example, after Cᵤₚ 1105 is determined from the voltage at Vₒᵤₜ 1215 (V_{cap in} FIG. 14G), switch 815 can be asserted by a voltage on Vᵣₑₛₑₜ 895 to short V_{com} electrode 865 and V_{d} electrode 860 to position movable element 870 back to the reset position. Movable element can be repositioned back to the same intended position, and the technique described above can be repeated with Vₜₑₛₜ 1390 that is the same voltage as V_{com} electrode 865 to determine C_{down} 1110. When both C_{down} 1110 and Cᵤₚ 1105 are determined, controller 29 can determine the position of movable element 870 because the two data points provided by C_{down} 1110 and Cᵤₚ 1105 can be used to extrapolate a straight line data set that can be used to determine the position of movable element 870. If the determined, actual position differs from the expected position, then controller 29 can update the LUT voltage data (e.g., by adjusting the voltage) for moving to the position so that movable element 870 can be positioned accurately.

The techniques described above may be performed during a calibration mode. For example, when a device incorporating display array 30 starts up, a calibration mode may be entered in which controller 29 may position movable element 870 to each color as indicated in the LUT, as previously described. For example, movable element 870 may be positioned to a position corresponding with red by looking up the appropriate voltage in the LUT, C_{down} 1110 and Cᵤₚ 1105 can be determined, and if necessary, controller 29 can adjust the voltage in the LUT. Next, controller 29 can position movable element 870 to a position corresponding with blue by using the LUT in a similar manner, determining C_{down} 1110 and Cᵤₚ 1105, and adjust the voltage in the LUT if movable element 870's actual position differs from the expected position.

In some implementations, C_{down} 1110 and Cᵤₚ 1105 of a single display unit 750 may be determined. However, in other implementations, C_{down} 1110 and Cᵤₚ 1105 can be determined for a group of display units 750. For example, C_{down} 1110 and Cᵤₚ 1105 for an entire row of display units 750 can be determined.

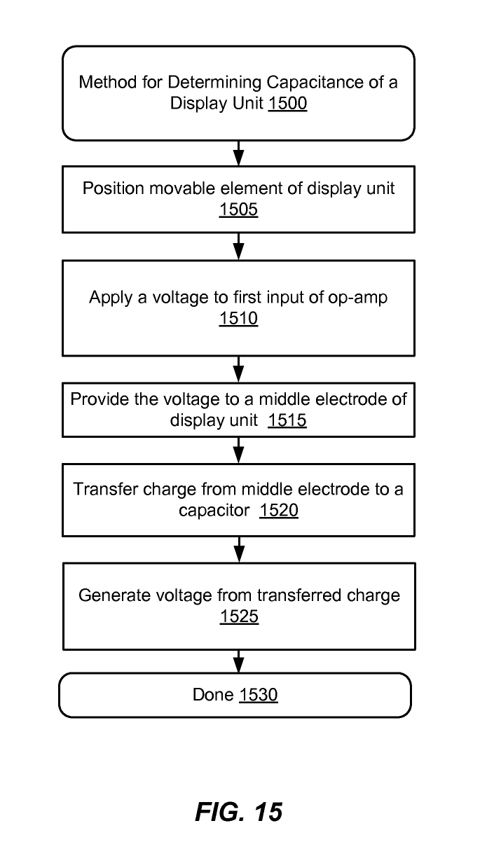

FIG. 15 is a flow diagram illustrating a method for measuring capacitance. In method 1500, at block 1505, a movable element of a display unit can be positioned. For example, movable element 870 can be positioned by controller 29 providing row driver circuit 24 and column driver circuit 26 to position towards an intended position. At block 1510, a voltage can be applied to a first input of an op-amp. For example, V_{data} 920 can be set to Vₜₑₛₜ and be provided to the positive input of op-amp 1225. Vₜₑₛₜ can be at a same voltage as a voltage of one of the top or bottom electrodes of display unit 750. At block 1515, the voltage can be provided to a middle electrode of a display unit. For example, the voltage can be provided to V_{d} electrode 860 when switch 810 is closed. At block 1520, charge can be transferred from the middle electrode to a capacitor. For example, V_{bias} electrode 855 can be set to 0 V, V_{data} can be set to 0 V, and integrator reset switch 1210 can be opened. At block 1525, a voltage can be generated from the transferred charge. For example, the charge accumulated upon integrator capacitor 1220 can generate a voltage Vₒᵤₜ 1215 that can be used to determine the position of movable element 870.

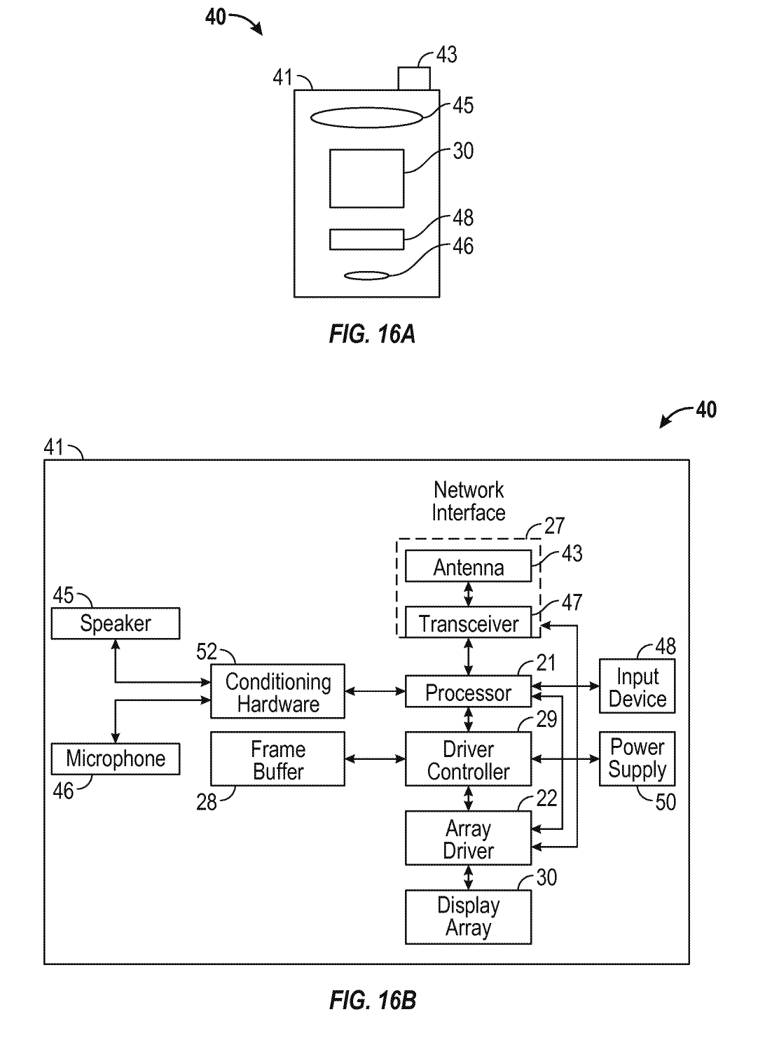

FIGS. 16A and 16B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 16A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 16A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

As previously discussed, the techniques and circuits disclosed herein can be used in other types of pixels, such as in LCDs. Additionally, they may be used with other types of devices where capacitances between electrodes are measured.

What is claimed is:

1. A circuit capable of injecting charge onto a first electrode of a display unit, and the circuit further capable of transferring the charge on the first electrode to a capacitor to generate a voltage corresponding to a capacitance between the first electrode and a second electrode of the display unit.

2. The circuit of claim 1, wherein the circuit comprises:
an operational amplifier (op-amp) having a first input, a second input, and an output; and
a switch having a first terminal and a second terminal, the first terminal coupled with the first input of the op-amp, the second terminal coupled with the output of the op-amp, and wherein the capacitor has a first terminal and a second terminal, the first terminal coupled with the first terminal of the op-amp, the second terminal coupled with the output of the op-amp.

3. The circuit of claim 2, wherein the switch is turned on to short the output of the op-amp with the first terminal of the op-amp to inject the charge onto the first electrode.

4. The circuit of claim 3, wherein a test voltage at the second output of the op-amp is provided to the first electrode to inject the charge.

5. The circuit of claim 4, wherein the test voltage corresponds to a voltage of a third electrode of the display unit, and the capacitance corresponds to a capacitance between the first electrode and the second electrode.

6. The circuit of claim 4, wherein the first electrode is positioned between the second electrode and the third electrode.

7. The circuit of claim 3, wherein the switch is turned off to no longer short the output of the op-amp with the first terminal of the op-amp to transfer the charge on the first electrode to the capacitor, wherein the first terminal of the op-amp is a negative input of the op-amp, and the first terminal of the op-amp is electrically coupled with the first electrode when the switch is turned off.

8. The circuit of claim 1, wherein the capacitance indicates a position of the first electrode.

9. The circuit of claim 1, further comprising:
a display including a plurality of the display units;
a processor that is configured to communicate with the display, the processor being configured to process image data; and
a memory device that is configured to communicate with the processor.

10. The circuit of claim 9, further comprising:
a driver circuit including the circuit and configured to send at least one signal to the display; and
a controller configured to send at least a portion of the image data to the driver circuit.

11. The circuit of claim 9, further comprising:
an image source module configured to send the image data to the processor, wherein the image source module includes at least one component selected from the group consisting of a receiver, a transceiver, and a transmitter.

12. The circuit of claim 1, wherein the middle electrode is associated with a movable element capable of being positioned between the second electrode and a third electrode of the display unit.

13. A system comprising:
a pixel having a first electrode and a second electrode;
a capacitor;
a charging circuit capable of injecting charge onto the first electrode, and the circuit capable of transferring the charge on the first electrode to the capacitor to generate an output voltage corresponding to a capacitance between the first electrode and the second electrode of the pixel; and
a controller capable of determining a state of the pixel based on the output voltage.

14. The system of claim 13, wherein the state of the pixel is associated with a position of a movable element associated with the first electrode in relation to the second electrode and a third electrode of the pixel, and the controller is further capable of determining that the position of the movable element differs from an expected position of the movable element, and the controller is further capable of updating data indicating a voltage to be applied to the first electrode based on the determination that the position of the movable element differs from the expected position of the movable element.

15. The system of claim 13, wherein the charging circuit comprises:
an operational amplifier (op-amp) having a first input, a second input, and an output; and
a switch having a first terminal and a second terminal, the first terminal coupled with the first input of the op-amp, the second terminal coupled with the output of the op-amp, and wherein the capacitor has a first terminal and a second terminal, the first terminal coupled with the first terminal of the op-amp, the second terminal coupled with the output of the op-amp.

16. The system of claim 15, wherein the switch is turned on to short the output of the op-amp with the first terminal of the op-amp to inject the charge onto the first electrode.

17. The system of claim 16, wherein a test voltage at the second output of the op-amp is provided to the first electrode to inject the charge, the test voltage corresponding to a voltage of a third electrode of the pixel.

18. The system of claim 17, wherein the switch is turned off to no longer short the output of the op-amp with the first terminal of the op-amp to transfer the charge on the first electrode to the capacitor.

19. A method comprising:
changing a state of a display unit having a first electrode and a second electrode;
applying a test voltage to an input of an operational amplifier (op-amp);
providing the test voltage to the first electrode of the display unit;
transferring charge from the electrode to a capacitor; and
generating a voltage from the transferred charge on the capacitor, the voltage corresponding to a capacitance between the first electrode and the second electrode of the display unit.

20. The method of claim 19, further comprising:
determining a position of the first electrode in relation to the second electrode based on the voltage.
